(19) United States
(12) Patent Application Publication
(10) Pub. No.: US 2010/0098253 A1
(43) Pub. Date: Apr. 22, 2010

(54) Broadcast Identity-Based Encryption

(75) Inventor: Cécile Delerablee, Caen (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 12/529,117

(22) PCT Filed: Feb. 25, 2008
(86) PCT No.: PCT/FR2008/050305

§ 371 Date: Aug. 28, 2009

(30) Foreign Application Priority Data
Feb. 28, 2007 (FR) 0701451

(51) Int. Cl. H04L 9/00

(52) U.S. Cl. 380/259; 380/44

(57) ABSTRACT

A public key (PK) dependent on a secret key is accessible to a sender entity (2) and to recipient entities. A private key that can be associated with a recipient entity depends on the secret key and on an identity parameter (IDⱼ) of said entity. Encryption of a message (M) intended for a set of s recipient entities (s>1) comprises generating a symmetrical encryption key (K) and an associated cryptogram (Hdr), as a function of the public key, from the identity parameters of the s recipient entities and a number chosen by the sender entity. The cryptogram allows access to the associated encryption key by combination with the public key, the identity parameters of the s recipient entities and the private key of an identified recipient entity of the set. The message is encrypted in the sender entity with the generated encryption key and is broadcast in this encrypted form, accompanied by said cryptogram.

The present invention relates to the technique of identity-based encryption of data or messages.

Identity-based encryption schemes, hereafter referred to as IBE schemes, were introduced in order to facilitate the message encryption phase.

An IBE scheme allows a sender to encrypt a message for an addressee, without the need to store a certificate of this addressee or a public key decoupled from his identity. The public key of the addressee is in fact deduced from his identity.

An IBE scheme can in particular be used for the encryption of electronic messages. A person A desiring to send a message to an addressee B typically uses the email address of B in order to obtain the encryption key to be used. A trusted authority provides, to each user identifying himself, a private decryption key corresponding to his email address, i.e. to his public key. For that reason, B has no need to make a public key, certified or not, known to A, to enable A to send him encrypted messages. This greatly simplifies administration of the system. It is even possible for A to encrypt a message for B before B has obtained his private key for decryption.

Certain IBE schemes make use of the properties of bilinear applications, for example that described in “Practical Identity-Based Encryption Without Random Oracles”, C. Gentry, Eurocrypt 2006, Vol. 196, Lecture Notes in Computer Science 4004, pages 445-464.

In IBE systems, the keys to be stored are usually short. However, at the present time there is no known means of efficiently encrypting a message for the attention of a group of users in such a system. In order to send an encrypted message to N users with the help of their identities, it is necessary to encrypt the message N times with N different keys and transmit N encrypted messages or, if a broadcast channel is employed, to broadcast information having the size of N encrypted messages. The information to be sent then has a linear size according to the number of addressees, which is not efficient when the number N becomes large.

An aspect of the invention relates to an identity-based cryptographic method, wherein a public key dependent on a secret key is accessible to a sender entity and to recipient entities, and respective private decryption keys can be associated with the recipient entities. The private key of a recipient entity depends on the secret key and an identity parameter of this recipient entity. The method comprises an operation of encryption of at least one message intended for a set of s recipient entities, s being a number greater than 1. This encryption operation comprises the steps of:
generating at least one symmetrical encryption key and a cryptogram associated with said symmetrical encryption key as a function of the public key, the identity parameters of the s recipient entities and at least one integer chosen by the sender entity, the cryptogram being generated so that it has a size that is constant and independent of the number s, and that it provides access to said symmetrical encryption key by combination with the public key, the identity parameters of the s recipient entities and the private key of an identified recipient entity of said set;
encrypting the message with said symmetrical encryption key in the sender entity; and
broadcasting the cryptogram and the encrypted message from the sender entity.

Thus it is possible to obtain an IBE scheme in the context of broadcast encryption. “Broadcast encryption” refers to cryptographic techniques employed for broadcasting content on a non-secure public channel, such that only legitimate users are able to read this content. Legitimate users are for example those that have paid for access rights. The sender entity that broadcasts a content desires this content to remain confidential vis-à-vis illegitimate users, which requires a particular encryption scheme. An example of broadcast encryption is described in “Broadcast encryption”, A. Fiat and M. Naor, CRYPTO'93, Lecture Notes in Computer Science, Vol. 773, pages 480-491, Santa Barbara, Calif., USA, Aug. 22-26, 1994. Springer-Verlag, Berlin.

By reconciling the IBE scheme and broadcast encryption, a scheme is obtained, hereafter called BIBE (“broadcast identity-based encryption”), suited to various contexts of application, such as for example efficiently constituting broadcast lists of encrypted electronic messages. BIBE schemes can be constructed with or without random oracle (a “random oracle” is a theoretical cryptographic device capable of responding to any request by a perfectly random answer taken uniformly from its values domain, said answer being the same each time the same request is made).

Moreover, contrary to the prior art, the cryptogram providing access to the encryption key has a size that is constant and independent of the number of recipient entities. Thus a limit can easily be set to the quantity of data to be broadcast.

Moreover, the decryption (and encryption) keys used can also have a constant size, and can be relatively small and independent of the number s. This property is suited to a software implementation.

In an embodiment, the encryption operation comprises a first phase of computing and storing a vector of intermediate values as a function of the public key and the identity parameters of the s recipient entities, and at least one instance of a second phase executed by the sender entity. This second phase comprises the steps of:
picking an integer;
computing a symmetrical encryption key and the associated cryptogram as a function of the picked integer and the vector of intermediate values, without again taking account of the identity parameters of the s recipient entities;
encrypting a message with the computed encryption key; and
broadcasting the computed cryptogram and the encrypted message.

Thus, the first phase of the encryption operation will only be carried out once for a single set of receivers targeted by a sender entity during a determined period. This is very suitable for the context of video encryption for example. A video intended for a certain set of users is encrypted throughout its broadcast for this set of users. The first phase of the encryption operation consisting of computing the vector of intermediate values can be carried once and for all at the start of the video, while the symmetrical encryption key can be updated regularly (for example every second) by carrying out the second phase repetitively, obtaining successive random numbers. This diversification of the keys effectively prevents them being fraudulently obtained if certain users seek to make public or communicate the symmetrical encryption key during the video broadcast. On the part of the recipient entity, the decryption operation can also be divided into two phases, the first carried out once, taking account of the identity parameters of the other recipient entities of the set and the second capable of being repeated several times without taking account of the identity parameters of the other recipient entities.

A BIBE scheme that can be used employs a secret key including an element g of a cyclic group G₁ of order p and an integer γ chosen between 1 and p−1, where p denotes a prime number. The public key can then have a component representing an element w of the group G₁ equal to g^{γ}, a component representing an element h of a cyclic group G₂ of order p, a component representing an element v of a cyclic group G_{T} of order p, in the form v=e(g, h), and components representing m elements of the group G₂ in the form h^{γ}, h^{γ}^{²}, . . . , h^{Y}^{^{m}}, where e(., .) denotes a bilinear application from G₁×G₂ into G_{T}, and m denotes an integer not less than the above-mentioned number s. With respect to the private key of a recipient entity, it can have a component representing an element Aⱼ of the group G₁ in the form Aⱼ=g^{1/(γ+x}^{ⱼ}⁾ where xⱼ is an integer determined by the identity parameters of said recipient entity.

In such a scheme, the symmetrical encryption key for a set of s recipient entities (2≦s≦m) can be determined by the element v^{k.(γ+x}^{₁}^{) . . . (γ+x}^{ₛ}⁾ of the group G_{T}, where x₁, . . . , xₛ are the integers determined by the respective identity parameters of the s recipient entities. It can moreover be provided for the cryptogram to have a component representing the element C₁=w^{k} of the group G₁ and a component representing the element C₂=h^{k.(γ+x}^{₁}^{) . . . (γ+x}^{ₛ}⁾ of the group G₂, where k is the integer chosen by the sender entity. A decryption operation carried out by one of the s recipient entities, of which the private key has a component representing the element Aᵢ=g^{1/(γ+x}^{ᵢ}⁾, can comprise a re-computation of the symmetrical encryption key based on the element e(C₁, zᵢ).e(Aᵢ^{x}^{ᵢ}, C₂) of the group G_{T}, where zᵢ is the element of the group G₂ equal to h^{Π}^{_{j=1,j≠i}}^{^{S}}^{(γ+x}^{ⱼ}⁾.

Computer programs are also proposed for encryption and decryption devices constituting sender and recipient entities in an identity-based cryptographic method such as that described above. On the sender side, the program comprises instructions for implementing the steps of an encryption operation of the method during an execution of the program by a processor unit of an encryption device. On the recipient side, the program comprises instructions for implementing the steps of a decryption operation of the method during an execution of the program by a processor unit of a decryption device.

Another aspect of the invention relates to an encryption device comprising:
a data store for containing a public key of an identity-based encryption scheme, the public key being dependent on a secret key and moreover being accessible to recipient entities, the identity-based encryption scheme further including a capacity to associate the respective private keys with the recipient entities, the private key of a recipient entity being dependent on the secret key and an identity parameter of said recipient entity;
a generator of at least one symmetrical encryption key and a cryptogram associated with said encryption key as a function of the public key, the identity parameters of a set of s recipient entities and a locally-chosen integer, s being a number greater than 1, said cryptogram being generated so that it has a size that is constant and independent of the number s, and that it provides access to said symmetrical encryption key by combination with the public key, the identity parameters of the s recipient entities and the private key of an identified recipient entity of said set; and
a circuit for encrypting the message with said symmetrical encryption key, the encrypted message being broadcast with the cryptogram.

A further aspect of the invention relates to a decryption device comprising:
a data store for containing a public key of an identity-based encryption scheme, as well as a private key associated with said device, the public key being dependent on a secret key and moreover being accessible to at least one sender entity, the identity-based encryption scheme further including a capacity to associate the respective private keys with recipient entities, including the decryption device, the private key of a recipient entity dependent on the secret key and an identity parameter of said recipient entity;
a computer for recovering a symmetrical encryption key based on a cryptogram received with an encrypted message coming from the sender entity, the public key, the identity parameters of a set of s recipient entities including said device and the private key associated with said device, s being a number greater than 1 and said cryptogram having a constant size and being independent of the number s; and
a circuit for decrypting the message with the symmetrical encryption key.

Other features and advantages of the invention will become apparent during the following description of non-limitative embodiments, with reference to the attached drawings, in which:

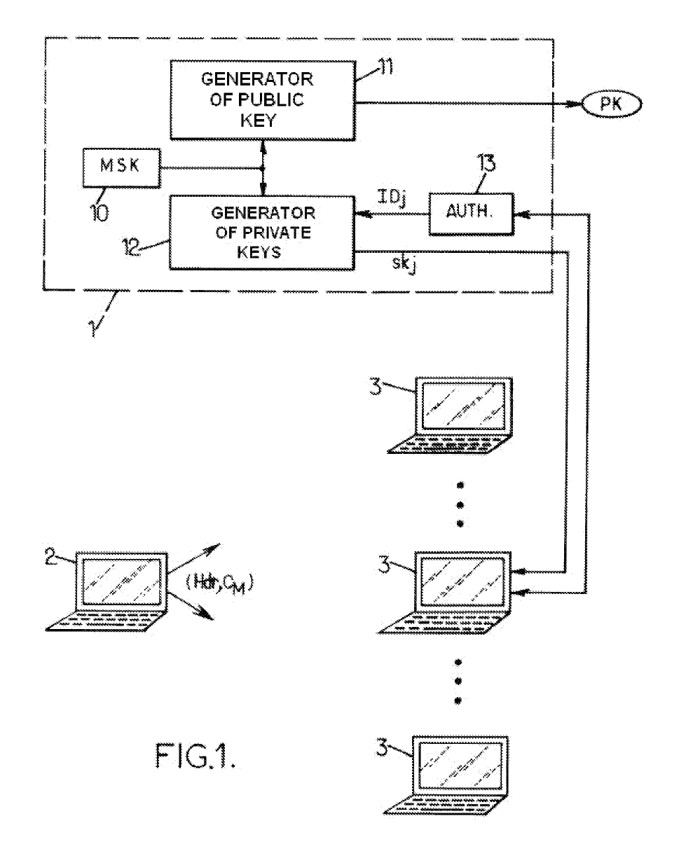

FIG. 1 is a block diagram of an encryption system for implementing an embodiment of the invention;

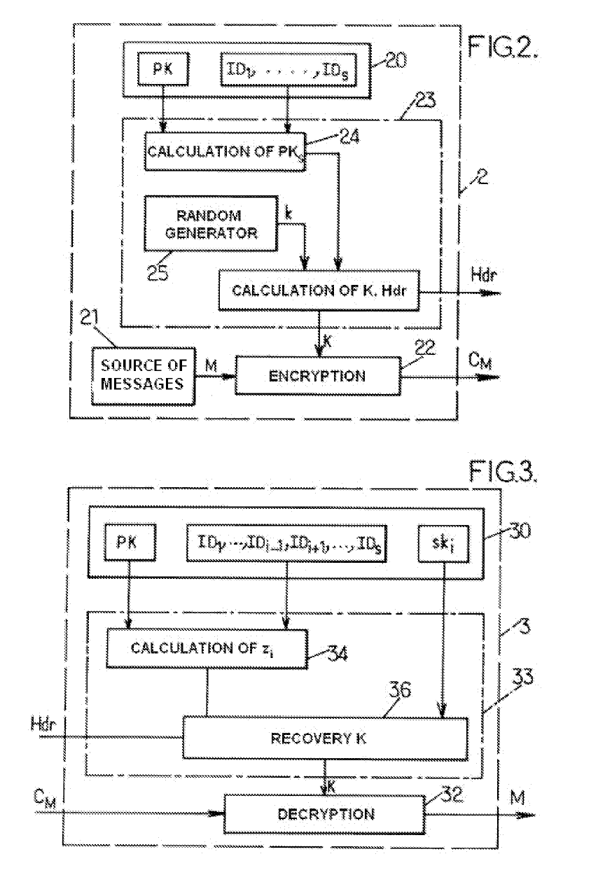

FIG. 2 is a block diagram of an example of an encryption device; and

FIG. 3 is a block diagram of an example of a decryption device.

The cryptographic method considered here involves a trusted authority 1. This authority is in principle the only entity holding a secret key or master key MSK. The authority keeps it for example in a protected data store 10.

During initialisation of the system, a public key generator 11 of the authority 1 determines a public key PK and broadcasts it so that it is available to all users of the system. The public key PK is computed as a function of the secret key MSK and system parameters representing the underlying mathematical structure of the encryption scheme.

Moreover, the authority 1 has a private-key generator 12 that is used to provide a private key specific to a recipient entity 3 which has identified itself to the authority 1. Private keys can be delivered at the time of initialization. However, according to a feature of IBE schemes, they are advantageously generated and sent to their holders as and when the need arises. An entity can in particular receive encrypted messages for its attention without yet holding a private key for decryption. By identifying itself to the authority 1, this entity can subsequently obtain its private key and decrypt the message.

The authority 1 has a module 13 implementing a technique for authentication of recipient entities 3 that request their private key. Once the entity 3 has been authenticated, its identity IDⱼ is provided to the private-key generator 12 which returns the corresponding private key skⱼ computed as a function of IDⱼ, the secret key MSK and the system parameters and sent to the entity via a protected channel.

The identity IDⱼ of a recipient entity 3 consists of one or more parameters publicly associated with the entity. Any identity used in known IBE schemes can be adopted (see A. Shamir, “Identity-based cryptosystems and signature schemes”, Advances in Cryptology—CRYPTO'84, Vol. 196, Lecture Notes in Computer Science, pages 47-53, Santa Barbara, Calif., USA, Aug. 19-23, 1985. Springer-Verlag, Berlin). A typical example of identity is the email address. Other parameters can be added to it, at the choice of the entity concerned, such as for example an indication of the validity period of the private key associated with the entity. A hash function can be applied to the identity in order to obtain a data item of the desired size.

The public key PK made available to each one allows a sender entity 2 to encrypt messages M for a set of s recipient entities 3 each denoted by their identity. The sender entity 2 uses any symmetrical encryption technique, employing a key K that it generates, and broadcasts the encrypted message C_{M} along with a header or cryptogram Hdr.

This cryptogram Hdr is constructed so as to provide access to the symmetrical encryption key K to any entity having:
the public key PK (and the system parameters);
the identity parameters IDⱼ of the s recipient entities, addressees of the encrypted message; and the private key skᵢ of one of these recipient entities.

Each recipient entity of the set can thus use its private key skᵢ to recover the symmetrical encryption key K then decrypt the message C_{M}.

In certain embodiments, the cryptogram Hdr has a size that is constant and independent of the number s, which avoids having too much data to be transmitted with the encrypted messages when the number of addressees becomes substantial. The private keys skⱼ can themselves also have a size that is constant and independent of the number s.

FIG. 2 diagrammatically shows the organisation of an encryption device 2 constituting a sender entity in an embodiment of the cryptographic method. The device 2 comprises a data store 20 where are stored in particular the public key PK and the identities ID₁, . . . , ID_{S} of the s recipient entities that will be the addressees of one or more encrypted messages C_{M}. The messages coming from a source 21 are encrypted in a circuit 22 using a symmetrical encryption key K produced by a generator 23. The identities IDⱼ can in particular form part of the address book of an email application.

Based on the public key PK and identities ID₁, . . . , ID_{S}, the encryption key generator 23 produces both a symmetrical encryption key K, and also an associated cryptogram Hdr. Producing the pair (K, Hdr) involves picking a random number k by a random-number generator 25.

It is possible to arrange that the computations taking account of the identities IDⱼ of the s recipient entities of the set are executed once only for all transmissions of encrypted messages to this set of s recipient entities. To this end, in a first phase, a module 24 of the encryption-key generator 23 computes a vector of intermediate values PK_{S} as a function of the public key PK and the identities IDⱼ of the s recipient entities, and stores this vector PK_{S}. Then, each time there is a new message to encrypt for these s recipient entities, a number k is picked and a module 26 computes a new pair (K, Hdr) as a function of k and PK_{S}.

It will be noted that as the computation of PK_{S} involves only the public parameters, this vector PK_{S} could be computed outside the encryption device 2 and received by the latter over a channel which need not be protected (the vector PK_{S} can be public).

FIG. 3 diagrammatically shows the organisation of a decryption device 3 constituting a recipient entity IDᵢ, in an embodiment of the cryptographic method. The device 3 comprises a data store 30 where are stored in particular the public key PK, the private key skᵢ of the device and the identities ID₁, . . . , IDᵢ₋₁, IDᵢ₊₁, ID_{S} of the s−1 recipient entities that will be, with the device 3, the addressees of one or more encrypted messages C_{M}. The identities IDⱼ can in particular form part of the address book of an email application.

Based on the public key PK and the identities ID_{S}, a computer 33 recovers a symmetrical encryption key K from the cryptogram Hdr received with an encrypted message C_{M}. It is possible to arrange that the computations taking account of the identities IDⱼ are executed once only for all receptions of encrypted messages that will be sent to the same set of s recipient entities. To this end, in a first phase, a module 34 of the computer 33 computes an intermediate value z, as a function of the public key PK and the identities IDⱼ of the s recipient entities, and stores this value zᵢ. Then, each time there is a new message to decrypt intended for these s recipient entities, a module 36 computes the symmetrical encryption key K based on the cryptogram Hdr received with the encrypted message C_{M} and the intermediate value zᵢ. It will be noted once again that as the computation of Z, involves only the public parameters, this value zᵢ could be computed outside the encryption device 3 and received by the latter over a channel which need not be protected.

In an example of a mathematical environment that can be used in the above method, two cyclic groups G₁ and G₂ (different or not) are defined, each of order p, where p is a prime number, typically having a binary representation or more than one hundred bits. A non-degenerate bilinear application e from G₁×G₂ into another cyclic group G_{T} is moreover defined. By bilinear is meant that for every pair of integers (a, b), every element u of G₁ and every element v of G₂, we have e(u^{a}, v^{b})=e(u, v)^{ab}. A possible example for this bilinear application e is the Tate pairing. The above-mentioned system parameters then comprise the number p and the descriptors of groups G₁, G₂ and G_{T} and the bilinear application e(., .).

In this example, the secret key MSK consists of an element g that the authority 1 obtains randomly out of group G₁ and an integer γ between 1 and p−1: MSK=(g, γ). The public key generator 11 computes the element w=g^{γ} of group G₁ and randomly picks an element h of the group G₂. It moreover computes the element v=e(g, h) of the group G_{T} and powers of the element h of the group G₂: h^{γ}, h^{γ}^{²}, . . . , h^{γ}^{^{m}}, where m is an integer representing the maximum size of the set of recipient entities 3 to which an encrypted message may be addressed. In other words the size s of a set of addressees could not be greater than m. The public key PK is then: PK=(w, v, h, h^{γ}, h^{γ}^{²}, . . . , h^{γ}^{^{m}}).

The private key skⱼ of an entity 3 having an identity IDⱼ consists in this case of an element A′ⱼ of the group G₁ representing the element Aⱼ=g^{1/(γ+x}^{ⱼ}⁾, where xⱼ is an integer determined by IDⱼ only. This element A′ⱼ is given by A′ⱼ=A′ⱼ=Aⱼ^{x}^{ⱼ}=g^{x}^{ⱼ}^{/(γ+x}^{ⱼ}⁾. Typically, xⱼ is obtained by applying a cryptographic hash function H to the binary representation of the identity: xⱼ=H(IDⱼ). The function H is also described in the known system parameters of the different entities.

In this example, the symmetrical encryption key K generated for encrypting a message M intended for s recipient entities having identities ID₁, . . . , ID_{S}, after obtaining a random number k, is determined by the element v^{k.(γ+x}^{₁}^{) . . . (γ+x}^{ₛ}⁾ of group G₁, with x₁=H(ID₁), . . . , xₛ=H(ID_{S}). The key K can be equal to v^{k.(γ+x}^{₁}^{) . . . (γ+x}^{ₛ}⁾ or more generally to F[v^{k.(γ+x}^{₁}^{) . . . (γ+x}^{ₛ}⁾], where F[.] denotes any function whatever known by the different entities owing to the system information. Computation of the element v^{k.(γ+x}^{₁}^{) . . . (γ+x}^{ₛ}⁾ by the encryption device involves the powers of h included in the public key PK, and makes use of the equation v^{γ}^{^{q}}=e(w, h^{γ}^{^{q−1}}) resulting from the property of the bilinear application e(., .), for 0<q≦m.

In order to provide the authorized entities with access to this key K, the cryptogram Hdr computed by the generator 23 to be sent with the message C_{M} encrypted with K includes the element C₁=w^{k} of group G₁ and the element C₂=h^{k.(γ+x}^{₁}^{) . . . (γ+x}^{ₛ}⁾ of group G₂: Hdr=(C₁, C₂).

A recipient entity 3 of the set of s entities, addressees of the encrypted message C_{M}, having as a private key skᵢ=A′ᵢ, is capable of recovering the key K used, by computing firstly the element zᵢ of the group G₂ equal to h^{Π}^{_{j=1,j≠i}}^{^{S}}^{(γ+x}^{ⱼ}⁾ then, based on the cryptogram Hdr=(C₁, C₂) received with the encrypted message, the element e(C₁, zᵢ).e(A′ᵢ, C₂) of group G_{T}. Due to the properties of the bilinear application e(., .), it is possible to verify that if the private key skᵢ=A′ᵢ is valid, this element e(C₁, zᵢ).e(A′ᵢ, C₂) of group G_{T} is equal to h^{k.(γ+x}^{₁}^{) . . . (γ+x}^{ₛ}⁾. The symmetrical encryption key K is thus recovered according to: K=F[e(C₁, zᵢ).e(A′ᵢ, C₂)].

Alternatively, it is possible to take the private keys skⱼ equal to the elements Aⱼ=g^{1/(γ+x}^{ⱼ}⁾ and have the exponentiation computed by the recipient entities 3 during decryption: K=F[e(C₁, zᵢ).e(Aᵢ^{x}^{ᵢ}, C₂)]. It is however more efficient to compute the exponentiation once for all during generation of the private key.

When a vector of intermediate values PK_{S} is computed by a module 24 of the encryption device as shown in FIG. 2, this vector PK_{S} includes the three elements w, a and b of groups G₁, G₂ and G_{T}, with a=h^{(γ+x}^{₁}^{) . . . (γ+x}^{ₛ}⁾ and b=v^{(γ+x}^{₁}^{) . . . (γ+x}^{ₛ}⁾. Elements a and b can be computed by the module 24 based on the public key PK=(w, v, h, h^{γ}, h^{γ}^{²}, . . . , h^{γ}^{^{m}}) and the integers x₁, . . . , xₛ deduced from the recipient identities ID₁, . . . , ID_{S} of the recipient entities of the set concerned. After obtaining the random number k, the module 26 computes K and Hdr=(C₁, C₂) in accordance with: K=b^{k}, C₁=w^{k} and C₂=a^{k}.

Due to the fact that the groups G₁, G₂ and G_{T} are cyclic of order p, the sums of the integers in the exponents given above can be understood as modulo p sums.

The example BIBE scheme described above uses a random oracle since a cryptographic hash function H is used to ensure the random character of the keys. As the random oracle model is a theoretical notion, it is possible to use a hash function only for compressing the identity data, without the need to assume the existence of a random oracle. It will be noted that other embodiments of the scheme do not use a random oracle. An example relying on similar mathematical constructs is described below. Here, we have no need of the above-mentioned assumption; nevertheless it is possible to use a hash function. The level of security provided by the hash function is then lower.

Based on the number p, cyclic groups G₁, G₂ and G_{T} and the bilinear application e(., .) mentioned previously, a secret key MSK=(g, γ, α) is obtained with g chosen at random from the group G₁, γ and α, integers comprised between 1 and p−1. The public key PK is constructed by choosing an element h of the group G₂, by computing h₂=h^{α} then PK=(w, v, h, h^{γ}, h^{γ}^{²}, . . . , h^{γ}^{^{m}}, h₂, h₂^{γ}, h₂^{γ}^{²}, . . . , h₂^{γ}^{^{m}}), the number m being defined as previously.

The private key skⱼ of an entity 3 having an identity IDⱼ is generated, based on computing two elements Aⱼ and Bⱼ of the groups G₁ and G₂, given by Aⱼ=g^{1/(γ+x}^{ⱼ}^{+r}^{_{j.α}}⁾ and Bⱼ=h.h₂^{-r}^{ⱼ}^{/(γ+x}^{ⱼ}^{+r}^{_{j.α}}⁾, where rⱼ is a number that the private key generator 12 picks randomly between 1 and p−1 for the recipient entity, and xⱼ is an integer determined only by IDⱼ. This integer xⱼ has no need to be generated using a cryptographic hash function. It can be taken equal to the identity IDⱼ in binary representation: xⱼ=IDⱼ. Powers of the element Bⱼ are computed in order to produce the private key skⱼ=(Aⱼ, rⱼ, Bⱼ, Bⱼ^{γ}, Bⱼ^{γ}^{²}, . . . , Bⱼ^{γ}^{^{m−1}})

In this example, the symmetrical encryption key K generated in order to encrypt a message M intended for s recipient entities of identities ID₁, . . . , ID_{S}, after obtaining a random number k, has the form K=F[v^{k.(γ+x}^{₁}^{) . . . (γ+x}^{ₛ}⁾], with x₁=ID₁, . . . , xₛ=ID_{S} and F[.] being any function whatever known by the different entities.

In order to provide the authorized entities with access to this key K, the cryptogram Hdr computed by the generator 23 to be sent with the message C_{M} encrypted with K includes the element C₁=w^{k} of the group G₁ and two elements C₂=h^{k.(γ+x}^{₁}^{) . . . (γ+x}^{ₛ}⁾ and C₃=h₂^{k.(γ+x}^{₁}^{) . . . (γ+x}^{ₛ}⁾ of the group G₂: Hdr=(C₁, C₂, C₃).

A recipient entity 3 of the set of s entities, addressees of the encrypted message C_{M}, is capable of recovering the key K used in computing firstly the element zᵢ of the group G₂ equal to Bᵢ^{Π}^{_{j=1,j≠i}}^{^{S}}^{(γ+x}^{ⱼ}⁾ then, based on the cryptogram Hdr=(C₁, C₂, C₃) received with the encrypted message, the element e(C₁, zᵢ).e(Aᵢ^{x}^{ᵢ}, C₂).e(Aᵢ^{r}^{ᵢ}, C₃) of group G_{T}. Due to the properties of the bilinear application e(., .), it is possible again to verify that if the private key skᵢ=(Aᵢ, rᵢ, Bᵢ, Bᵢ^{γ}, Bᵢ^{γ}^{²}, . . . , Bᵢ^{γ}^{^{m−1}}) is valid, then e(C₁, zᵢ).e(Aᵢ^{x}^{ᵢ}, C₂).e(Aᵢ^{r}^{ᵢ}, C₃)=v^{k.(γ+x}^{₁}^{) . . . (γ+x}^{ₛ}⁾. The symmetrical encryption key K is thus recovered by the formula: K=F[e(C₁, zᵢ).e(Aᵢ^{x}^{ᵢ}, C₂).e(Aᵢ^{r}^{ᵢ}, C₃)].

Alternatively, the private keys skⱼ can be taken in the form Skⱼ=(A′ⱼ, A″ⱼ, Bⱼ, Bⱼ^{γ}, Bⱼ^{γ}^{²}, . . . , Bⱼ^{γ}^{^{m−1}}) with A′ⱼ=Aⱼ^{x}^{ⱼ} and A″ⱼ=Aⱼ^{r}^{ⱼ}. In this case, the recipient entity 3 holding the private key skᵢ recovers the symmetrical encryption key K according to K=F[e(C₁, zᵢ).e(A′ᵢ, C₂).e(A″ᵢ, C₃)], without the need to recompute the powers of Aᵢ. In this variant, A′ⱼ represents Aⱼ, while in the previous variant, rⱼ, paired with Aⱼ, represents A″ⱼ=Aⱼ^{r}^{ⱼ}.

When a vector of intermediate values PK_{S} is computed by a module 24 of the encryption device as shown in FIG. 2, this vector PK_{S} includes the four elements w, a, a₂ and b of groups G₁, G₂ et G_{T}, with a=h^{(γ+x}^{₁}^{) . . . (γ+x}^{ₛ}⁾, a₂=h₂^{(γ+x}^{₁}^{) . . . (γ+x}^{ₛ}⁾ and b=v^{(γ+x}^{₁}^{) . . . (γ+x}^{ₛ}⁾. After obtaining the random number k, the module 26 computes K and Hdr=(C₁, C₂, C₃) in accordance with: K=b^{k}, C₁=w^{k}, C₂=a^{k} and C₃=a₂^{k}.

It is noted that if we take α=0 in the above scheme without a random oracle, we return to the scheme with a random oracle described previously, rⱼ no longer being necessary. The keys are randomized by the fact that the integers xⱼ then depend on the identities IDⱼ through a cryptographic hash function.

The encryption and decryption devices shown in FIGS. 2 and 3 can be implemented by means of specific circuitry or programmable logic components of the FPGA type or the like. A typical implementation will however use processors in general use, executing programs according to the invention, written so as to implement the cryptographic computations described above.

1. An identity-based cryptographic method, wherein a public key dependent on a secret key is accessible to a sender entity and to recipient entities, and wherein respective private decryption keys can be associated with the recipient entities, the private key of a recipient entity being dependent on the secret key and an identity parameter of said recipient entity, the method comprising an operation of encryption of at least one message intended for a set of s recipient entities, s being a number greater than 1, the encryption operation comprising:
generating at least one symmetrical encryption key and a cryptogram associated with said symmetrical encryption key as a function of the public key, the identity parameters of the s recipient entities and at least one integer chosen by the sender entity, said cryptogram being generated so that it has a size that is constant and independent of the number s, and that it provides access to said symmetrical encryption key by combination with the public key, the identity parameters of the s recipient entities and the private key of an identified recipient entity of said set;
encrypting the message with said symmetrical encryption key in the sender entity; and
broadcasting the cryptogram and the encrypted message from the sender entity.

2. The cryptographic method according to claim 1, wherein the private keys have a constant size independent of the number s.

3. The cryptographic method according to claim 1, wherein the encryption operation further comprises a first phase of computing and storing a vector of intermediate values as a function of the public key and the identity parameters of the s recipient entities, and at least one iteration of a second phase executed by the sender entity and comprising:
picking an integer;
computing a symmetrical encryption key and the associated cryptogram as a function of the picked integer and the vector of intermediate values, without again taking account of the identity parameters of the s recipient entities;
encrypting a message with the computed symmetrical encryption key; and
broadcasting the computed cryptogram and the encrypted message.

4. The cryptographic method according to claim 3, wherein the encryption operation comprises several iterations of the second phase for the encryption and broadcast of successive messages by the sender entity.

5. The cryptographic method according to claim 1, comprising a decryption operation carried out by at least one of the s recipient entities, the decryption operation comprising:
recovering the symmetrical encryption key based on the cryptogram, the public key, the identity parameters of the s recipient entities and the private key of said recipient entity; and
decrypting the message broadcast with the recovered symmetrical encryption key.

6. The cryptographic method according to claim 5, wherein the decryption operation carried out by said recipient entity comprises a first phase of storing at least one intermediate value determined as a function of the public key and the identity parameters of the other recipient entities of the set, and at least one iteration of a second phase comprising:
recomputing the symmetrical encryption key as a function of the cryptogram received with an encrypted message coming from the sender entity, of said intermediate value and the private key of said recipient entity, without again taking account of the identity parameters of the other recipient entities of the set; and
decrypting said message with the recomputed symmetrical encryption key.

7. The cryptographic method according to claim 6, wherein the decryption operation comprises several iterations of the second phase for the decryption of messages successively received with respective cryptograms from the sender entity.

8. An encryption device, comprising:
a data store for containing a public key of an identity-based encryption scheme, the public key being dependent on a secret key and being moreover accessible to recipient entities, the identity-based encryption scheme further including a capacity to associate respective private keys with the recipient entities, the private key of a recipient entity being dependent on the secret key and an identity parameter of said recipient entity;
a generator of at least one symmetrical encryption key and a cryptogram associated with said encryption key as a function of the public key, the identity parameters of a set of s recipient entities and a locally-chosen integer (k), s being a number greater than 1, said cryptogram being generated so that it has a size that is constant and independent of the number s, and that it provides access to said symmetrical encryption key by combination with the public key, the identity parameters of the s recipient entities and the private key of an identified recipient entity of said set; and
a circuit for encrypting the message with said symmetrical encryption key, the encrypted message being broadcast with the cryptogram.

9. The encryption device according to claim 8, wherein the generator is arranged to store a vector of intermediate values computed in a first phase as a function of the public key and the identity parameters of the s recipient entities and to execute a second phase of computing a symmetrical encryption key and the associated cryptogram as a function of an integer picked in the second phase and the vector of intermediate values, without again taking account of the identity parameters of the recipient entities, the second phase being repeatable for broadcasting successive encrypted messages intended for the s recipient entities.

10. A decryption device, comprising:
a data store for containing a public key of an identity-based encryption scheme as well as a private key associated with said device, the public key being dependent on a secret key and being moreover accessible to at least one sender entity, the identity-based encryption scheme further including a capacity to associate the respective private keys with recipient entities including the decryption device, the private key of a recipient entity being dependent on the secret key and an identity parameter of said recipient entity;
a computer for recovering a symmetrical encryption key based on a cryptogram received with an encrypted message coming from the sender entity, the public key, the identity parameters of a set of s recipient entities including said device and the private key associated with said device, s being a number greater than 1 and said cryptogram having a constant size and being independent of the number s; and
a circuit for decrypting the message with the symmetrical encryption key.

11. The decryption device according to claim 10, wherein the computer is arranged to store at least one intermediate value computed in a first phase as a function of the public key and the identity parameters of the other recipient entities of the set, and to execute a second phase of computing a symmetrical encryption key as a function of a cryptogram received with an encrypted message coming from a sender entity, said intermediate value and the private key associated with said device, without again taking account of the identity parameters of the other recipient entities of the set, the second phase being renewable for receiving successive encrypted messages intended for the s recipient entities.

12. (canceled)

13. (canceled)

14. A computer-readable medium, having a program stored thereon for an encryption device, the program comprising instructions for implementing an encryption operation during an execution of the program by a processor unit of the encryption device, wherein the encryption operation for encrypting at least one message intended for a set of s recipient entities, s being a number greater than 1, comprises:
generating, under control of the program, at least one symmetrical encryption key and a cryptogram associated with said symmetrical encryption key as a function of a public key of an identity-based encryption scheme, identity parameters of the s recipient entities and at least one integer chosen locally, the public key being dependent on a secret key and being accessible to the recipient entities, the identity-based encryption scheme including a capacity to associate respective private keys with the recipient entities, the private key of a recipient entity being dependent on the secret key and on the identity parameter of said recipient entity, said cryptogram being generated so that it has a size that is constant and independent of the number s, and that it provides access to said symmetrical encryption key by combination with the public key, the identity parameters of the s recipient entities and the private key of an identified recipient entity of said set;
encrypting the message with said symmetrical encryption key under control of the program; and
broadcasting the cryptogram and the encrypted message.

15. The computer-readable medium according to claim 14, wherein the encryption operation further comprises:
in a first phase carried out under control of the program, computing a vector of intermediate values as a function of the public key and the identity parameters of the s recipient entities;
storing the vector of intermediate values computed in the first phase; and
executing a second phase under control of the program, the second phase comprising picking an integer and computing a symmetrical encryption key and the associated cryptogram as a function of said integer and said vector of intermediate values, without taking account of the identity parameters of the recipient entities, the second phase being repeatable for broadcasting successive encrypted messages intended for the s recipient entities.

16. A computer-readable medium, having a program stored thereon for an decryption device, the program comprising instructions for implementing a decryption operation during an execution of the program by a processor unit of the decryption device, wherein the encryption operation for encrypting at least one message intended for a set of s recipient entities, s being a number greater than 1, comprises:
recovering, under control of the program, a symmetrical encryption key based on a cryptogram received with an encrypted message coming from a sender entity, a public key of an identity-based encryption scheme, identity parameters of a set of s recipient entities including said decryption device and a private key associated with said decryption device, s being a number greater than 1, the public key being dependent on a secret key and being accessible to the sender entity and the recipient entities, the identity-based encryption scheme including a capacity to associate respective private keys with the recipient entities, the private key of a recipient entity being dependent on the secret key and on the identity parameter of said recipient entity, said cryptogram being generated so that it has a size that is constant and independent of the number s; and
decrypting the message with the symmetrical encryption key under control of the program.

17. The computer-readable medium according to claim 16, wherein the decryption operation further comprises:
in a first phase carried out under control of the program, computing at least one intermediate values as a function of the public key and the identity parameters of the other recipient entities of the set;
storing said at least one intermediate values computed in the first phase; and
executing a second phase under control of the program, the second phase comprising computing a symmetrical encryption key as a function of a cryptogram received with an encrypted message coming from a sender entity, said intermediate value and the private key associated with said decryption device, without taking account of the identity parameters of the other recipient entities of the set, the second phase being renewable for receiving successive encrypted messages intended for the s recipient entities.

18. A cryptographic method according to claim 1, wherein the secret key includes an element g of a cyclic group G₁ of order p and an integer γ chosen between 1 and p−1, where p denotes a prime number,
wherein the public key has a component representing an element w of the group G₁ equal to g^{γ}, a component representing an element h of a cyclic group G₂ of order p, a component representing an element v of a cyclic group G_{T} of order p, in the form v=e(g, h), and components representing m elements of the group G₂ in the form h^{γ}, h^{γ}^{²}, . . . , h^{γ}^{^{m}}, where e(., .) denotes a bilinear application from G₁×G₂ into G_{T}, and m denotes an integer not less than s,
wherein the private key of a recipient entity has a component representing an element Aⱼ of the group G₁ in the form Aⱼ=g^{1/(γ+x}^{ⱼ}⁾ where xⱼ is an integer determined by the identity parameters of said recipient entity,
wherein the symmetrical encryption key for a set of s recipient entities (2≦s≦m) is determined by the element v^{k.(γ+x}^{₁}^{) . . . (γ+x}^{ₛ}⁾ of the group G_{T}, where x₁, . . . , xₛ are the integers determined by the respective identity parameters of the s recipient entities, and
wherein the cryptogram has a component representing the element C₁=w^{k} of the group G₁ and a component representing the element C₂=h^{k.(γ+x}^{₁}^{) . . . (γ+x}^{ₛ}⁾ of the group G₂, where k is the integer chosen by the sender entity.

19. The cryptographic method according to claim 18, further comprising a decryption operation carried out by at least one of the s recipient entities, wherein the decryption operation carried out by one of the s recipient entities, of which the private key has a component representing the element Aᵢ=g^{1/(γ+x}^{ᵢ}⁾ comprises:
re-computating the symmetrical encryption key based on the element e(C₁, zᵢ).e(Aᵢ^{x}^{ᵢ}, C₂) of the group G_{T}, where zᵢ is the element of the group G₂ equal to h^{Π}^{_{j=1,j≠i}}^{^{S}}^{(γ+x}^{ⱼ}⁾; and
decrypting the message broadcast with the recovered symmetrical encryption key.
